(19) United States
(12) Patent Application Publication
(10) Pub. No.: US 2023/0256983 A1
(43) Pub. Date: Aug. 17, 2023

(54) VEHICLE CONTROLLER, VEHICLE CONTROL METHOD AND RECORDING MEDIUM

(71) Applicant: HONDA MOTOR CO., LTD., Tokyo (JP)

(72) Inventors: Hisahiro Kato, Tokyo (JP); Hiroaki Hakukawa, Tokyo (JP); Satoshi Aiyoshizawa, Tokyo (JP); Takayuki Inomata, Tokyo (JP); Seiju Kawamata, Tokyo (JP)

(21) Appl. No.: 18/157,121

(22) Filed: Jan. 20, 2023

(30) Foreign Application Priority Data
Feb. 15, 2022 (JP) 2022-021064
Aug. 31, 2022 (JP) 2022-137520

(51) Int. Cl. B60W 50/06; G06F 8/65; G07C 5/08; G07C 5/00

(52) U.S. Cl. CPC B60W 50/06; G06F 8/65; G07C 5/085; G07C 5/0816; G07C 5/008

(57) ABSTRACT

A vehicle controller includes: a vehicle control unit configured to control a vehicle by executing a vehicle starting program for starting the vehicle; a storage unit including a rewrite limited area where the vehicle starting program is stored and rewrite is limited and a rewrite possible area where the vehicle starting program is rewritably stored; a communication unit configured to communicate with an external device; and a program update unit configured to execute update processing of storing a vehicle starting update program received by the communication unit and utilized for updating the vehicle starting program in the rewrite possible area, in which the vehicle control unit executes the vehicle starting program stored in the rewrite possible area and executes the vehicle starting program stored in the rewrite limited area when the update processing by the program update unit is not normally completed.

### INCORPORATION BY REFERENCE

The present application claims priority under 35 U.S.C.§ 119 to Japanese Patent Application No. 2022-021064 filed on Feb. 15, 2022 and Japanese Patent Application No. 2022-137520 filed on Aug. 31, 2022. The content of applications is incorporated herein by reference in its entirety.

### BACKGROUND OF THE INVENTION

### Field of the Invention

The present invention relates to a vehicle controller, a vehicle control method and a recording medium.

### Description of the Related Art

In recent years, functions of software which controls a vehicle have been enriched for purposes of improving traffic safety and reducing CO₂ discharge. Then, a technology of updating a program executed by an electronic control unit (ECU) loaded on a vehicle has been proposed. For example, Japanese Patent Laid-Open No. 2019-144669 discloses a configuration in which a storage unit that stores a program includes a vehicle control program storage area to store a control program and a second program storage area to store an update program which is an updated version of the control program. With the configuration, it is said that the update program can be stored in the storage unit even while the control program is being executed and restrictions on a timing of updating the program can be reduced.

Software which controls a vehicle includes an important program for performing basic operations of the vehicle. When such a program is damaged, the operations of the vehicle are greatly affected. Therefore, it is demanded to secure reliability regarding processing of updating the program.

The present invention has been made in consideration of such a background and an object of the present invention is to secure reliability regarding update of a program which controls a vehicle.

### SUMMARY OF THE INVENTION

One aspect for achieving the object described above is a vehicle controller including: a vehicle control unit configured to control a vehicle by executing a vehicle starting program for starting the vehicle; a storage unit including a rewrite limited area and a rewrite possible area, the vehicle starting program being stored in the rewrite limited area, rewrite being limited in the rewrite limited area, the vehicle starting program being rewritably stored in the rewrite possible area; a communication unit configured to communicate with an external device; and a program update unit configured to execute update processing of storing a vehicle starting update program in the rewrite possible area, the vehicle starting update program being received by the communication unit, the vehicle starting update program being utilized for updating the vehicle starting program, wherein the vehicle control unit executes the vehicle starting program stored in the rewrite possible area and executes the vehicle starting program stored in the rewrite limited area when the update processing by the program update unit is not normally completed.

According to the configuration described above, even when a trouble occurs in update of a program for starting a vehicle, the vehicle can be started by utilizing a program stored in an area where rewrite is limited. Thus, reliability regarding update of a program which controls a vehicle can be secured.

### BRIEF DESCRIPTION OF THE DRAWINGS

FIG. 1 is a schematic block diagram of a control system of a vehicle;

FIG. 2 is a diagram illustrating a schematic configuration of a program management system;

FIG. 3 is a block diagram illustrating a main section configuration of the control system in a first embodiment;

FIG. 4 is a schematic diagram illustrating a configuration example of a storage unit in the first embodiment;

FIG. 5 is a flowchart illustrating an operation of the control system in the first embodiment;

FIG. 6 is a flowchart illustrating the operation of the control system in the first embodiment;

FIG. 7 is a schematic diagram illustrating a configuration example of the storage unit in a second embodiment;

FIG. 8 is a flowchart illustrating the operation of the control system in the second embodiment;

FIG. 9 is a flowchart illustrating the operation of the control system in the second embodiment; and

FIG. 10 is a flowchart illustrating the operation of the control system in the second embodiment.

### DETAILED DESCRIPTION OF THE PREFERRED EMBODIMENTS

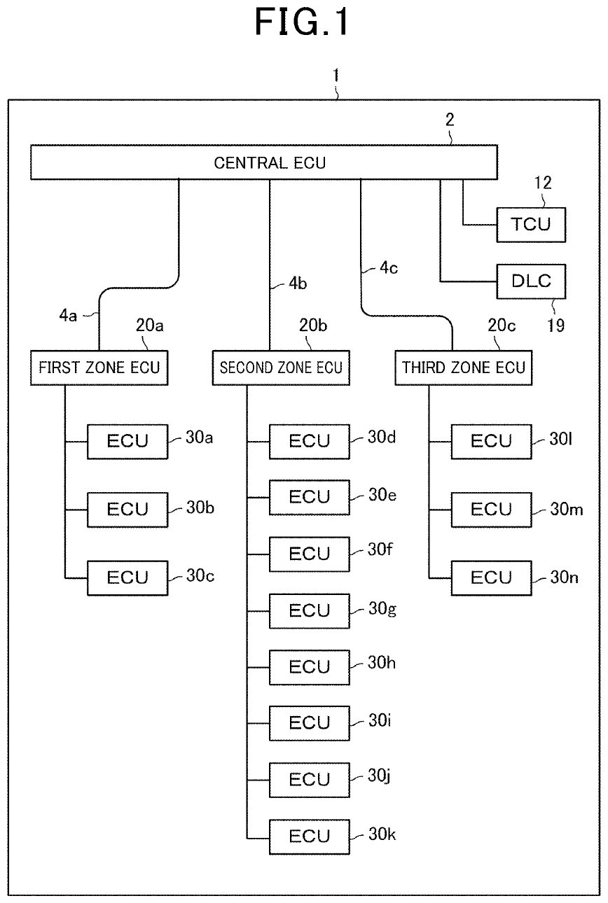

FIG. 1 is a diagram illustrating a control system 1 of a vehicle.

The control system 1 includes a central ECU 2 which performs overall control of the vehicle and information processing. Hereinafter, the vehicle loaded with the control system 1 is referred to as a present vehicle. The present vehicle is specifically a vehicle V to be described later. The central ECU 2 is connected to communication lines including communication lines 4a, 4b and 4c. The central ECU 2 achieves a function of a gateway which manages exchange of communication data among the communication lines. In addition, to the central ECU 2, a telematics control unit (TCU) 12 which is a wireless device based on a communication standard of a mobile communication system is connected. The central ECU 2 utilizes the TCU 12 to execute Over-The-Air (OTA) management. The OTA management includes control regarding processing of downloading an update program of an in-vehicle device provided in the vehicle from a server outside the vehicle and processing of applying the downloaded update program to the in-vehicle device. In addition, to the central ECU 2, a data link connector (DLC) 19 is connected. To the DLC 19, a diagnostic device or the like to be described later can be connected.

To the communication lines 4a, 4b and 4c, a first zone ECU 20a, a second zone ECU 20b and a third zone ECU 20c are connected respectively. The numbers and kinds of ECUs to be connected to the first zone ECU 20a, the second zone ECU 20b and the third zone ECU 20c are not limited and one configuration example is illustrated in the present embodiment. In this example, to the first zone ECU 20a, ECUs 30a, 30b and 30c are connected. To the second zone ECU 20b, ECUs 30d, 30e, 30f, 30g, 30h, 30i, 30j and 30k are connected. In addition, to the third zone ECU 20c, ECUs 30l, 30m and 30n are connected.

Hereinafter, the first zone ECU 20a, the second zone ECU 20b and the third zone ECU 20c are also referred to as zone ECUs 20 collectively and the ECUs 30a to 30n are also referred to as ECUs 30 collectively.

The ECUs 30 may include an ECU which controls operations of various devices and sensors provided in the present vehicle, such as a map positioning unit (MPU), a multi view camera (MVC)-ECU, a parking support (PKS)-ECU and/or an advanced driver-assistance system (ADAS)-ECU, and other. Such devices and sensors may include a motor for traveling which makes the present vehicle travel, a steering operation device such as an accelerator and a brake, a vehicle stability assist (VSA) device, a battery, a lamp body such as a head lamp, a window motor which drives a door window, an actuator which drives a door lock mechanism, a door lock sensor, a door opening/closing sensor, a temperature sensor, a vehicle exterior camera, a vehicle interior camera or the like.

To each of the zone ECUs 20, the plurality of ECUs 30 disposed in a same section of a vehicle body space of the present vehicle or the plurality of ECUs 30 which control the operations of the devices and sensors disposed in the same section are connected.

Note that, to the central ECU 2, other controllers and apparatuses may be connected in addition to the zone ECUs 20. Such controllers and apparatuses may include an infotainment control box (ICB), a speaker, a microphone, a meter panel, a steering switch, a global navigation satellite system (GNSS) sensor, a touch panel or the like.

The communication lines 4a, 4b and 4c are configured by CAN buses which perform communication based on a CAN communication standard for example, in the present embodiment. Hereinafter, the communication lines 4a, 4b and 4c are collectively referred to as communication lines 4. Here, the communication lines 4 correspond to an in-vehicle network in the present disclosure. In addition, the zone ECUs 20 connected to the communication lines 4 correspond to a plurality of electronic controllers in the present disclosure.

According to a conventional technology, the zone ECUs 20 connected to the communication lines 4 send out data to be transmitted to the communication lines 4 by one frame or as a column of a plurality of frames according to the CAN communication standard. According to the CAN communication standard, each frame to be sent out includes an identification code (ID), and each zone ECU 20 which receives the frame determines whether or not the frame is the frame transmitted to itself based on the ID included in the frame.

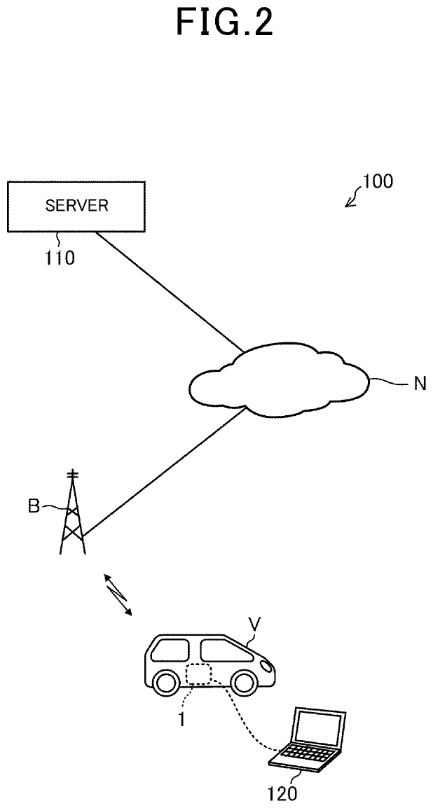

FIG. 2 is a diagram illustrating a schematic configuration of a program management system 100.

The program management system 100 is a system which makes it possible to update a program executed by various kinds of ECUs configuring the control system 1. The program management system 100 includes a server 110 and a vehicle diagnostic device 120.

The server 110 is connected with the control system 1 by a communication network N.

The communication network N includes, for example, a cellular communication network, a Wi-Fi® network, Bluetooth®, the Internet, a wide area network (WAN), a local area network (LAN), a public line, a provider device, a private line and a base station or the like, and a base station B is illustrated in FIG. 2. The TCU 12 provided in the control system 1 executes data communication with an external device through the communication network N by executing cellular communication with the base station B.

The control system 1 can download update data for updating the program executed by the various kinds of ECUs in the control system 1 from the server 110 by executing the communication with the server 110 by the TCU 12. Means for the control system 1 to download the update data from the server 110 and update the program corresponds to the OTA described above.

The server 110 corresponds to an example of the external device of the control system 1. The TCU 12 corresponds to an example of a communication unit.

The vehicle diagnostic device 120 is a device installed in a shop or a maintenance facility which handles the vehicle V loaded with the control system 1. The vehicle diagnostic device 120 is connected to the DLC 19 provided in the control system 1 by a cable. The control system 1 can update the program executed by the control system 1 or the like by executing the communication with the vehicle diagnostic device 120. The vehicle diagnostic device 120 can be an example of the external device configured with a computer, and the DLC 19 can be an example of the communication unit.

Here, update of the program of the ECU indicates rewrite of the program to be executed by the ECU to a program of a different version. The update of the program of the ECU may include the rewrite of data to be referred to when the ECU executes the program and/or the data generated or changed by the execution of the program together with the program. The update of the program of the ECU may include the rewrite of the program to be executed by the ECU to a program of the same version.

### First Embodiment

First, the first embodiment of the present disclosure will be explained.

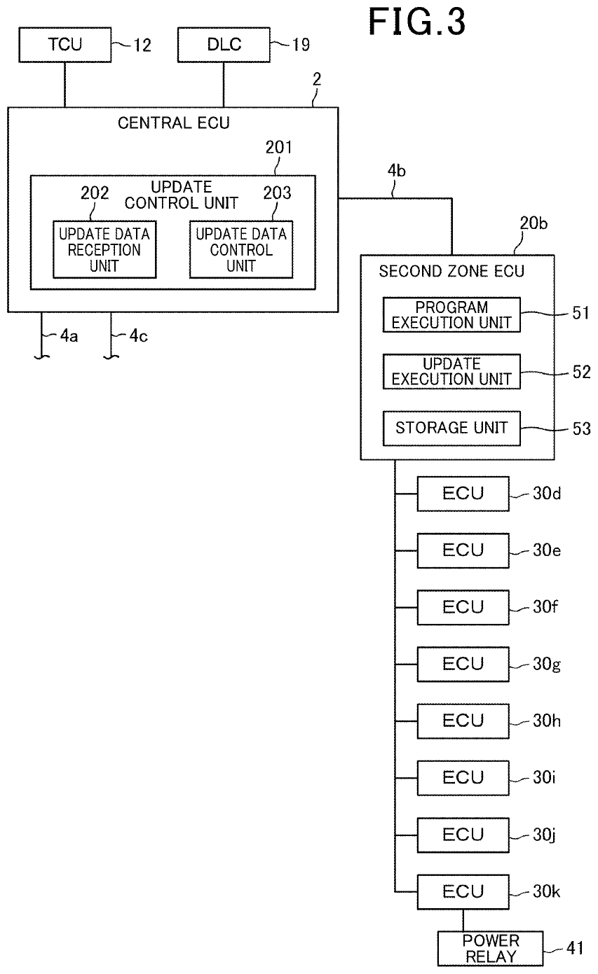

FIG. 3 is a block diagram illustrating a main section configuration of the control system 1 in the first embodiment. FIG. 3 illustrates a part of the configuration regarding the update of the program in the control system 1 and does not block the control system 1 from being provided with a configuration not illustrated in FIG. 3.

In the control system 1, each of the ECUs including the central ECU 2, the zone ECUs 20 and the ECUs 30 includes a processor and a storage unit (memory). The processor is configured by a central processing unit (CPU), a micro controller unit (MCU) and a micro processor unit (MPU), for example. The storage unit stores the program to be executed by the processor and the data to be processed by the processor in a nonvolatile manner. The storage unit is, for example, a read only memory (ROM). In addition, the ECU may include a random access memory (RAM) which forms a work area for temporarily storing the program and the data. The ECU may be configured by an integrated circuit integrally including the processor, the ROM and the RAM. Further, the ECU may include each of the processor, the ROM and the RAM as independent hardware.

The central ECU 2 includes an update control unit 201 as a functional unit related to the update of the program. The update control unit 201 may be hardware provided in the central ECU 2. In addition, the update control unit 201 may be a functional unit achieved by cooperation of software and hardware by the processor of the central ECU 2 executing the program.

The update control unit 201 includes an update data reception unit 202 and an update data control unit 203. The update data reception unit 202 controls the TCU 12 and receives the update data for updating the program from the server 110. The update data control unit 203 utilizes the update data received by the update data reception unit 202 and controls the processing of updating the program by the various kinds of ECUs including the central ECU 2.

In FIG. 3, the second zone ECU 20b is illustrated as an object of control by the update control unit 201, however, it is one example. The number of the ECUs to be the object of the control of the update control unit 201 is not limited. The update control unit 201 controls the update of the program to be executed by at least some of the ECUs provided in the control system 1. The update control unit 201 may control the update of the program by all the ECUs or almost all the ECUs provided in the control system 1.

As an example of the ECU which updates the program according to the control of the update control unit 201, the second zone ECU 20b will be explained in the present embodiment.

The second zone ECU 20b includes a program execution unit 51, an update execution unit 52 and a storage unit 53. The storage unit 53 corresponds to the storage unit (memory) described above. The program execution unit 51 executes the program stored in the storage unit 53. It can be said that the program execution unit 51 represents a function of the processor itself provided in the second zone ECU 20b. The program execution unit 51 corresponds to an example of a vehicle control unit. In addition, the control system 1 corresponds to an example of a vehicle controller. The storage unit 53 stores the program to be executed by the program execution unit 51 and the data related to the program. The update execution unit 52 updates the program stored in the storage unit 53. The update execution unit 52 corresponds to an example of a program update unit.

In the vehicle V, control objects of the second zone ECU 20b are the ECUs 30d to 30k illustrated in FIG. 1. Examples of the ECUs 30d to 30k are the ECUs which control a lamp body, a window motor, a door sensor, a door lock mechanism and ESL of the vehicle V. In addition, the examples of the ECUs 30d to 30k are the ECUs which control a wiper motor, a window washer motor and a power relay 41. In the present embodiment, the ECU 30k will be explained as the ECU which controls the power relay 41.

The wiper motor is a motor which operates a wiper of the vehicle V. The window washer motor is a motor which drives a window washer pump. The window washer pump is driven by the window washer motor and jets window washer liquid to a front window of the vehicle V.

The power relay 41 is a circuit which performs switching for switching a power supply state from a battery loaded on the vehicle V. The ECU 30k controls the power relay 41 based on a signal outputted by the second zone ECU 20b, and switches a power ON state of supplying power from the battery to individual units of the control system 1 and a power OFF state of stopping power supply to at least part of the control system 1. The power relay 41 is a contact relay, for example. The power relay 41 may be an element referred to as a solid state relay or a semiconductor relay, or other switching elements.

Here, the power ON state is a state where the vehicle V can be made to travel by operating a drive unit of the vehicle V. The drive unit is, for example, a motor or an internal combustion engine which drives the vehicle. For example, the power ON state includes a case where the vehicle V is traveling, a case where the vehicle V is stopped and the drive unit is operated, and a state where the drive unit can be operated. In contrast, the power OFF state is a state where at least the drive unit of the vehicle V is stopped and is the state where starting processing for operating the drive unit is required. In the power OFF state, configuration units other than the drive unit may be stopped in the control system 1.

For example, when the drive unit includes the internal combustion engine, the power OFF state is the state where the internal combustion engine is stopped and includes the state where a cell motor or the like which starts the internal combustion engine is not operated. In addition, for example, when the drive unit includes the motor, the power OFF state is the state where the power supply to the motor is stopped and the control of a drive state of the motor is stopped. In the power OFF state, the plurality of ECUs including the central ECU 2 and the second zone ECU 20b may be operated.

An operation that the control system 1 shifts from the power OFF state to the power ON state is referred to as starting here. In order to start the vehicle V, the power relay 41 needs to perform switching by controlling the ECU 30k by the second zone ECU 20b.

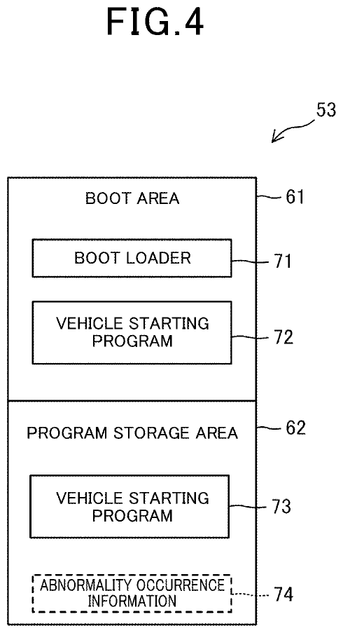

FIG. 4 is a schematic diagram illustrating a configuration example of the storage unit 53.

The storage unit 53 includes a nonvolatile storage area. The storage unit 53 rewritably stores the program and the data in the storage area. The storage unit 53 is configured by a semiconductor storage device or a magnetic recorder, for example. As a specific example, the storage unit 53 is configured by a flash ROM or an electronically erasable programmable ROM (EEPROM). In the following explanation, the program and the data stored in the storage unit 53 are described as the program. That is, the program mentioned in the following explanation includes the data referred to, generated or processed when the processor executes the program. The entire program and data can be rephrased as software. That is, the program management system 100 has a function of managing and updating the software of the control system 1 loaded on the vehicle V.

The storage area of the storage unit 53 is logically divided into a plurality of areas. That is, the storage unit 53 is provided with a boot area 61 and a program storage area 62. The boot area 61 and the program storage area 62 both store the program. The boot area 61 is an area where the rewrite by the update execution unit 52 is limited or inhibited. The boot area 61 corresponds to an example of a rewrite limited area. Therefore, the processing of updating the program stored in the boot area 61 by the update execution unit 52 is not performed. In contrast, the program storage area 62 is an area where the rewrite is possible by the update execution unit 52. The program storage area 62 corresponds to an example of a rewrite possible area. The update execution unit 52 can execute the processing of storing a new program in the program storage area 62 and the processing of updating the program stored in the program storage area 62. In addition, the boot area 61 may be an area set so as not to be an object of the processing of rewriting the program and the data by the update execution unit 52 without the need of completely inhibiting the rewrite. For example, the rewrite to the boot area 61 is not blocked from being executed by the control of the central ECU 2 and the vehicle diagnostic device 120 connected via the DLC 19.

Limitation of write to the boot area 61 may be the limitation by hardware or may be the limitation by software. For example, when the boot area 61 and the program storage area 62 are provided in the storage area of the same semiconductor storage device, the limitation to the boot area 61 is achieved by specifications of the update execution unit 52 or the software. In addition, for example, when the boot area 61 and the program storage area 62 are the storage area of different semiconductor storage devices, the limitation to the boot area 61 may be achieved by the hardware.

The boot area 61 stores a boot loader 71. The boot loader 71 is a program to be executed by the program execution unit 51 first when the second zone ECU 20b is to start the vehicle V. The program execution unit 51 executes initialization or the like required for the processing of the program execution unit 51 by executing the boot loader 71. Further, the program execution unit 51 reads and executes a vehicle starting program 73 stored in the program storage area 62 by a function of the boot loader 71.

The program storage area 62 stores a program to be executed by the program execution unit 51.

The program storage area 62 stores the vehicle starting program 73. The vehicle starting program 73 includes a program for starting the vehicle V by the second zone ECU 20b controlling the ECU 30k and operating the power relay 41. In addition, the vehicle starting program 73 may include a function of controlling a non-illustrated engine starter or the like.

The vehicle starting program 73 includes one or more programs for executing a basic operation of the vehicle V. That is, the vehicle starting program 73 includes functions essential for starting, traveling and stopping of the vehicle V. For example, the vehicle starting program 73 includes functions regarding the control of the door lock mechanism and the ESL.

In addition, the functions of the vehicle starting program 73 include the control demanded by law or the like to be executed while the vehicle V is traveling. For example, the vehicle starting program 73 includes a function regarding the control of lighting of the lamp body of the vehicle V, a function regarding the control of the wiper motor and a function regarding the control of the window washer motor.

The functions of the vehicle starting program 73 may include a function required for the update of the program in the control system 1. For example, the vehicle starting program 73 may include a function of executing the communication with the server 110 via the TCU 12 and a function of executing the communication with the vehicle diagnostic device 120 via the DLC 19.

In addition, the vehicle starting program 73 may include a program regarding the function not essential for the traveling of the vehicle V. For example, the vehicle starting program 73 may include a function regarding accessibility that improves convenience of a user and a function regarding infotainment that improves amusement of the user. Specifically, the functions of the vehicle starting program 73 may include a function of opening and closing a door in a hands-free manner and a function of giving performance by illumination of a vehicle interior space of the vehicle V or the like.

The boot area 61 stores a vehicle starting program 72 in addition to the boot loader 71.

The vehicle starting program 72 is executed by the program execution unit 51 similarly to the vehicle starting program 73, and is a program for controlling the individual units by the program execution unit 51. The vehicle starting program 72 includes one or more programs for executing the basic operation of the vehicle V, similarly to the vehicle starting program 73.

Specifically, the functions essential for the starting, traveling and stopping of the vehicle V and the control demanded by law or the like to be executed while the vehicle V is traveling are included. Accordingly, by the program execution unit 51 executing the vehicle starting program 72, at least it is made possible to start the vehicle V and make the vehicle V travel.

The vehicle starting program 72 may be a program not including the function regarding the accessibility that improves the convenience of the user and the function regarding the infotainment that improves the amusement of the user among the functions achieved by the vehicle starting program 73. In this case, since a storage capacity for storing the vehicle starting program 72 is smaller than that for the vehicle starting program 73, the storage capacity of the boot area 61 can be suppressed.

The vehicle starting program 73 stored in the program storage area 62 can be updated by the function of the update execution unit 52. In contrast, the vehicle starting program 72 stored in the boot area 61 is not updated by the update execution unit 52. For example, the vehicle starting program 72 is not changed from the state of being stored in the boot area 61 when the vehicle V is shipped from a factory. Accordingly, the vehicle starting program 72 is in the state of being protected regardless of the operation of the update execution unit 52. Even when some kind of trouble occurs in update processing that the update execution unit 52 updates the vehicle starting program 73, the control system 1 can start the vehicle V and make the vehicle V travel by executing the vehicle starting program 72 by the program execution unit 51.

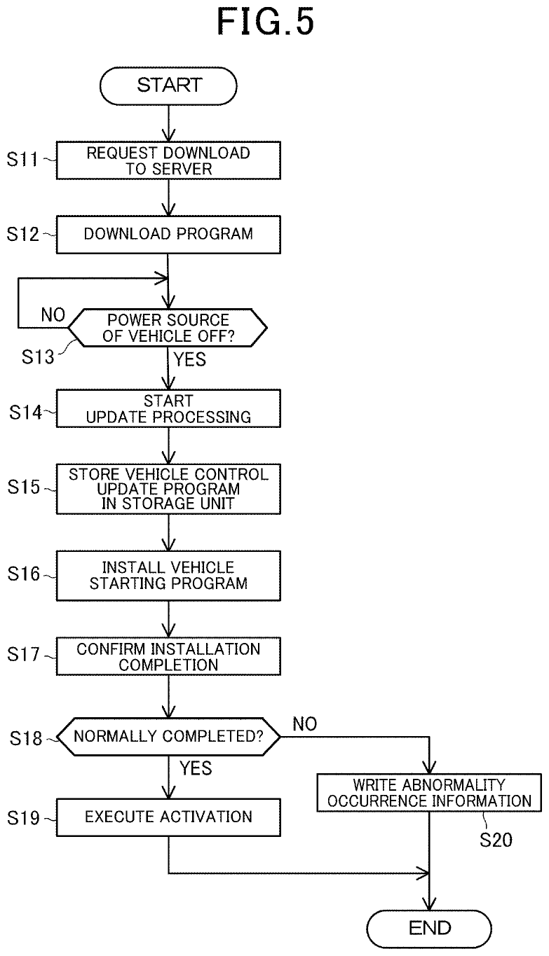

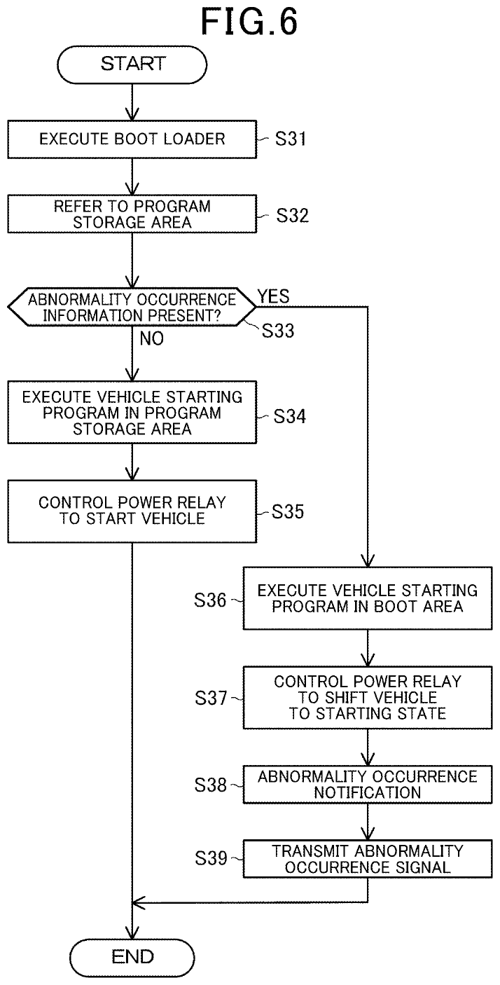

FIG. 5 and FIG. 6 are flowcharts illustrating the operation of the control system 1. FIG. 5 illustrates the processing of updating the vehicle starting program 73 stored in the program storage area 62. Steps S14 to S16 in FIG. 5 correspond to an example of the update processing.

The update data reception unit 202 transmits a request to the server 110 by the TCU 12 (step S11). The request in step S11 is a request of an update program for updating the program stored by the ECU, and is a request of transmission of a vehicle control update program for updating the vehicle starting program 73, for example.

The update data reception unit 202 downloads the program transmitted by the server 110 in response to the request in step S11 from the server 110, and temporarily stores the program in a non-illustrated storage area (step S12). Here, the update data control unit 203 stands by for a power source of the vehicle V to be switched OFF in order to start the update processing. That is, the update data control unit 203 determines whether or not the vehicle V is switched to the power OFF state (step S13). While the vehicle V is not switched to the power OFF state (step S13; NO), the update data control unit 203 stands by in step S13.

When it is determined that the vehicle V is switched to the power OFF state (step S13; YES), the update execution unit 52 starts the update processing according to the control of the update data control unit 203 (step S14).

In the update processing, the update execution unit 52 stores the vehicle control update program downloaded in step S12 in the program storage area 62 (step S15). The update execution unit 52 utilizes the vehicle control update program stored in the program storage area 62 to execute installation of the vehicle starting program 73 stored in the program storage area 62 (step S16). The processing in step S16 corresponds to the processing of updating the vehicle starting program 73 to the vehicle starting program 73 of a new version.

The update execution unit 52 performs the processing of confirming that the installation is normally completed (step S17). In step S17, the update execution unit 52 confirms that the installed program is in a state of being normally executable by the program execution unit 51. For example, the update execution unit 52 confirms normality of the updated vehicle starting program 73 by calculating a hash value of the updated vehicle starting program 73 and comparing the calculated hash value with a hash value downloaded from the server 110 together with the vehicle control update program.

The update execution unit 52 determines whether or not the installation of the vehicle starting program 73 is normally completed based on a result of the processing in step S17 (step S18). When the installation is normally completed (step S18; YES), the update execution unit 52 executes activation of the installed program (step S19) and ends the present processing. The activation includes setting regarding execution of the updated program.

When it is determined that the installation of the vehicle starting program 73 is not normally completed (step S18; NO), the update execution unit 52 writes abnormality occurrence information 74 in the program storage area 62 (step S20).

The abnormality occurrence information 74 is information indicating that the update processing of the vehicle starting program 73 is not normally completed. The abnormality occurrence information 74 may be a flag for example. In this case, the writing of the abnormality occurrence information 74 by the update execution unit 52 in step S20 corresponds to the rewrite of the flag of the abnormality occurrence information 74 to ON. When the abnormality occurrence information 74 is stored in the program storage area 62, the program execution unit 51 does not execute the vehicle starting program 73 upon starting. Thus, the vehicle starting program 73 with a possibility of being not normally operated can be prevented from being executed.

FIG. 6 illustrates the operation regarding the starting of the second zone ECU 20b.

The program execution unit 51 reads and executes the boot loader 71 stored in the boot area 61 (step S31). Next, the program execution unit 51 refers to the program storage area 62 (step S32), and determines whether or not the abnormality occurrence information 74 is stored (step S33). When the abnormality occurrence information 74 is not stored (step S33; NO), the program execution unit 51 executes the vehicle starting program 73 stored in the program storage area 62 (step S34). By executing the vehicle starting program 73, the program execution unit 51 makes the ECU 30k switch the power relay 41 to start the vehicle V (step S35). Thus, the state where the control system 1 can control the functions required for the traveling of the vehicle V is attained, and the vehicle V is shifted to the power ON state.

When the abnormality occurrence information 74 is stored in the program storage area 62 (step S33; YES), the program execution unit 51 executes the vehicle starting program 72 stored in the boot area 61 (step S36). By executing the vehicle starting program 72, the program execution unit 51 makes the ECU 30k switch the power relay 41 to start the vehicle V (step S37).

In this case, the update control unit 201 or the program execution unit 51 provides abnormality occurrence notification (step S38). The abnormality occurrence notification is notification indicating that the update processing of the vehicle starting program 73 is not normally completed.

The abnormality occurrence notification is executed to the user who is in a driver's seat or another seat of the vehicle V, for example. Contents of the abnormality occurrence notification guide the user to, for example, request re-execution of the update of the vehicle starting program 73 or update the vehicle starting program 73 by utilizing the vehicle diagnostic device 120 in the shop or the maintenance facility of the vehicle V. In step S38, the notification is executed by displaying characters and images on the touch panel loaded on the vehicle V or outputting voice from the speaker loaded on the vehicle V, for example.

After providing the abnormality occurrence notification, the update control unit 201 or the program execution unit 51 transmits an abnormality occurrence signal to the external device (step S39). The abnormality occurrence signal is a signal indicating that the update processing of the vehicle starting program 73 is not normally completed. The abnormality occurrence notification is transmitted to the server 110 by the TCU 12 or is transmitted to the vehicle diagnostic device 120 via the DLC 19, for example. In addition, the abnormality occurrence notification may be transmitted to a smartphone or a personal computer registered in the control system 1 beforehand, in step S39.

By transmitting the abnormality occurrence signal from the control system 1 to the server 110 and other devices, for example, it becomes possible to support the user driving the vehicle V regarding repair of the vehicle starting program 73 and redoing of the update from the shop or the maintenance facility of the vehicle V.

### Second Embodiment

Next, the second embodiment of the present disclosure will be explained.

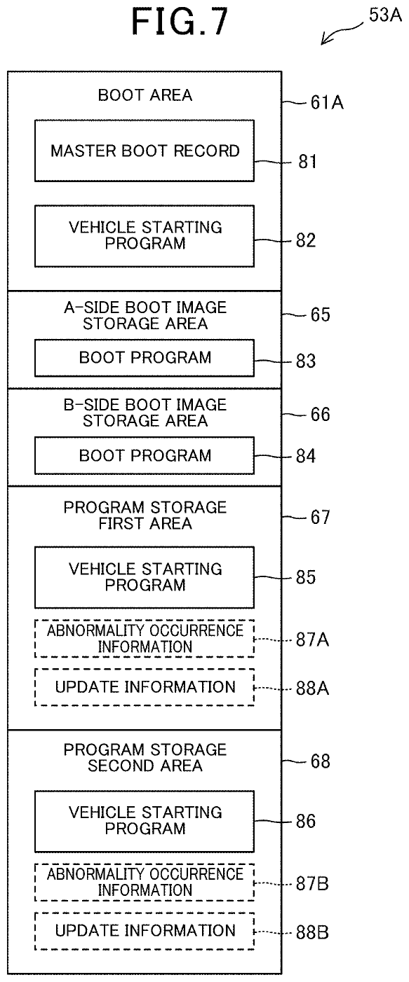

FIG. 7 is a schematic diagram illustrating a configuration example of a storage unit 53A in the second embodiment. The storage unit 53A is provided in the second zone ECU 20b, instead of the storage unit 53 illustrated in FIG. 3 and FIG. 4. The configuration and the functions of the control system 1 in the second embodiment are in common with the first embodiment except for a difference between the storage unit 53 and the storage unit 53A and a difference in the operation regarding the difference. For the configuration explained in the first embodiment, in the following explanation, illustrations and explanation are omitted by attaching the same signs as that in the first embodiment.

The storage unit 53A includes a nonvolatile storage area. The storage unit 53A rewritably stores the program and the data in the storage area. The storage unit 53A is configured by a semiconductor storage device or a magnetic recorder similarly to the storage unit 53, and is specifically configured by a flash ROM or an EEPROM.

The storage area of the storage unit 53A is logically divided into a plurality of areas. That is, the storage unit 53A is provided with a boot area 61A, an A-side boot image storage area 65, a B-side boot image storage area 66, a program storage first area 67 and a program storage second area 68. Each of the areas stores the program.

The boot area 61A stores a master boot record 81 and a vehicle starting program 82. The boot area 61A is configured similarly to the boot area 61 except that the program stored in the boot area 61A is different from the boot area 61.

The master boot record 81 is a program to be executed by the program execution unit 51 first when the second zone ECU 20b is to start the vehicle V. The program execution unit 51 refers to the master boot record 81, and the master boot record 81 includes a program corresponding to the boot loader 71 and data which specifies a program to be executed by the program execution unit 51 following the program corresponding to the boot loader 71 or the like. The program execution unit 51 executes the initialization or the like required for the processing of the program execution unit 51 by executing the program included in the master boot record 81. Further, the program execution unit 51 reads and executes a boot program 83 or a boot program 84 by the function of the boot loader 71.

The A-side boot image storage area 65 stores the boot program 83. The B-side boot image storage area 66 stores the boot program 84.

The boot program 83 is a program for executing the basic operation of the second zone ECU 20b and starting the execution of a vehicle starting program 85. The boot program 84 is a program for executing the basic operation of the second zone ECU 20b and starting the execution of a vehicle starting program 86.

Accordingly, the program execution unit 51 executes the boot program 83 and the vehicle starting program 85 or the boot program 84 and the vehicle starting program 86 following the master boot record 81.

The program storage first area 67 stores the vehicle starting program 85. The program storage second area 68 stores the vehicle starting program 86. The vehicle starting program 85 is a program similar to the vehicle starting program 73. The vehicle starting program 86 is also similar. In addition, the program storage first area 67 can store abnormality occurrence information 87A and update information 88A. The program storage second area 68 can store abnormality occurrence information 87B and update information 88B.

That is, the vehicle starting programs 85 and 86 include a program for switching the power relay 41 to start the vehicle V by the second zone ECU 20b operating the ECU 30k. In addition, the vehicle starting programs 85 and 86 may include the function of controlling the non-illustrated engine starter or the like.

The vehicle starting programs 85 and 86 include one or more programs for executing the basic operation of the vehicle V. In other words, the vehicle starting programs 85 and 86 include the functions essential for the starting, traveling and stopping of the vehicle V. For example, the vehicle starting programs 85 and 86 include the function of controlling a door lock mechanism 33 and an ESL 34. In addition, the functions of the vehicle starting programs 85 and 86 include the control demanded by law or the like to be executed while the vehicle V is traveling. For example, the vehicle starting programs 85 and 86 include a function of controlling lighting of the lamp body, a function of controlling the wiper motor and a function of controlling the window washer motor.

The functions of the vehicle starting programs 85 and 86 may include the function required for the update of the program in the control system 1. For example, the vehicle starting programs 85 and 86 may include the function of executing the communication with the server 110 via the TCU 12 and the function of executing the communication with the vehicle diagnostic device 120 via the DLC 19.

In addition, the vehicle starting programs 85 and 86 may include the program regarding the function not essential for the traveling of the vehicle V. For example, the vehicle starting programs 85 and 86 may include the function regarding the accessibility that improves the convenience of the user and the function regarding the infotainment that improves the amusement of the user. Specifically, the functions of the vehicle starting programs 85 and 86 may include the function of opening and closing a door in a hands-free manner and the function of giving performance by the illumination of the vehicle interior space of the vehicle V or the like.

Both of the vehicle starting program 85 and the vehicle starting program 86 are the program suited to the second zone ECU 20b. The vehicle starting program 85 and the vehicle starting program 86 may be the same program or may be different programs. For example, the vehicle starting program 85 and the vehicle starting program 86 are the programs of a same kind and are the programs of different versions. An example that the vehicle starting program 86 is the version newer than the vehicle starting program 85 is assumed. In this example, the vehicle starting program 86 is the program of an improved version for which functions are added to the vehicle starting program 85, for example. In addition, the vehicle starting program 86 is the program for which failures and vulnerability that the vehicle starting program 85 has are dissolved, for example.

The boot area 61A stores the vehicle starting program 82 in addition to the master boot record 81. The vehicle starting program 82 is executed by the program execution unit 51 similarly to the vehicle starting programs 85 and 86, and is the program for controlling the individual units by the program execution unit 51.

The vehicle starting program 82 includes one or more programs for executing the basic operation of the vehicle V, similarly to the vehicle starting programs 85 and 86. Specifically, the functions essential for the starting, traveling and stopping of the vehicle V and the control demanded by law or the like to be executed while the vehicle V is traveling are included. Accordingly, by the program execution unit 51 executing the vehicle starting program 82, at least it is made possible to start the vehicle V and make the vehicle V travel.

The vehicle starting program 82 may be the program not including the function regarding the accessibility that improves the convenience of the user and the function regarding the infotainment that improves the amusement of the user among the functions achieved by the vehicle starting programs 85 and 86. In this case, since the storage capacity for storing the vehicle starting program 82 is smaller than that for the vehicle starting programs 85 and 86, the storage capacity of the boot area 61A can be suppressed.

The storage area of the storage unit 53A is classified into an A side and a B side. To the A side, the A-side boot image storage area 65 and the program storage first area 67 belong. To the B side, the B-side boot image storage area 66 and the program storage second area 68 belong. The boot area 61A does not belong to either of the A side and the B side.

The storage area on the A side and the storage area on the B side store the programs independent of each other. The program execution unit 51 achieves the various kinds of functions of the second zone ECU 20b by utilizing the program stored in the storage area on either one of the A side and the B side. When the program execution unit 51 selects the A side, the program execution unit 51 executes the boot program 83 and the vehicle starting program 85 following the master boot record 81. In this case, the program execution unit 51 can control the individual units including the power relay 41 without executing the program on the B side. That is, when the program is normally stored on either one of the A side and the B side in the storage unit 53A, the program execution unit 51 can execute the operation as the second zone ECU 20b.

For updating the program stored in the storage unit 53A, the update execution unit 52 selects one of the A side and the B side. As an example, the case where the program of a version newer than the vehicle starting program 85 stored in the program storage first area 67 is provided by the server 110 is assumed. In this case, the update execution unit 52 updates the vehicle starting program 86 stored in the storage area different from the vehicle starting program 85. The update execution unit 52 downloads a vehicle control update program for updating the vehicle starting program 86 from the server 110, and updates the program stored in the program storage second area 68 based on the vehicle control update program. Thereafter, the update execution unit 52 changes the setting so that the program execution unit 51 executes the vehicle starting program 86 which is a new version.

The program storage first area 67 and the program storage second area 68 are the areas where the rewrite is possible by the update execution unit 52. The program storage first area 67 and the program storage second area 68 correspond to an example of the rewrite possible area. Accordingly, the update execution unit 52 can execute the processing of storing a new program and the processing of updating an already stored program to the program storage first area 67 and the program storage second area 68.

The boot area 61A is the area where the rewrite is limited or inhibited similarly to the boot area 61. The boot area 61A corresponds to an example of the rewrite limited area. Therefore, the processing of updating the program stored in the boot area 61A by the update execution unit 52 is not performed. Specifically, the vehicle starting program 82 does not become an object of the update processing executed by the update execution unit 52. For example, the vehicle starting program 82 is not changed from the state of being stored in the boot area 61A when the vehicle V is shipped from the factory. The boot area 61A may be an area set so as not to be an object of the processing of rewriting the program and the data by the update execution unit 52 without the need of completely inhibiting the rewrite. For example, the rewrite to the boot area 61A is not blocked from being executed by the control of the central ECU 2 and the vehicle diagnostic device 120 connected via the DLC 19.

The A-side boot image storage area 65 and the B-side boot image storage area 66 are not the object to rewrite the program by the update execution unit 52. For example, the A-side boot image storage area 65 and the B-side boot image storage area 66 are the area where the rewrite by the update execution unit 52 is limited, similarly to the boot area 61A.

The vehicle starting program 73 stored in the program storage area 62 can be updated by the function of the update execution unit 52. In contrast, the vehicle starting program 82 stored in the boot area 61A is not updated by the update execution unit 52. Accordingly, the vehicle starting program 82 is in the state of being protected regardless of the operation of the update execution unit 52. Even when some kind of trouble occurs in the update processing that the update execution unit 52 updates the vehicle starting program 85, and 86, the control system 1 can start the vehicle V and make the vehicle V travel by executing the vehicle starting program 82 by the program execution unit 51.

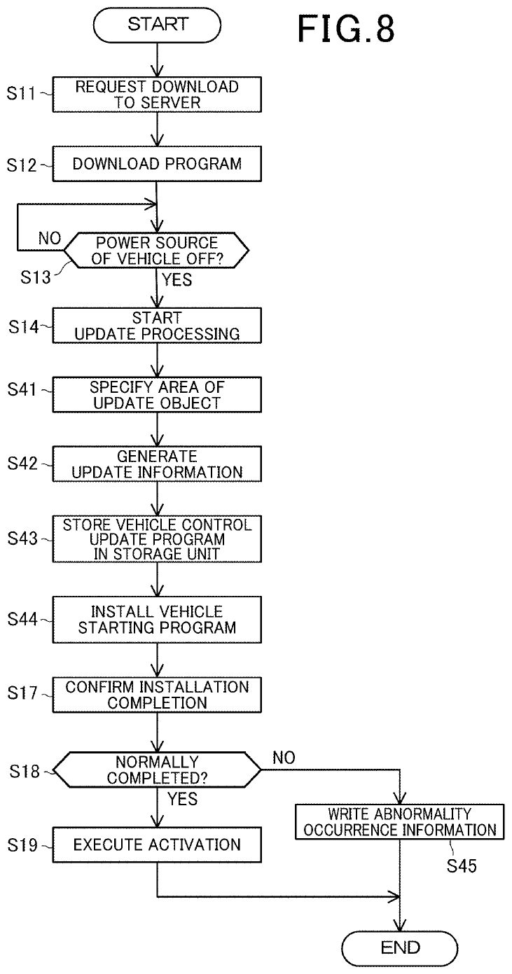

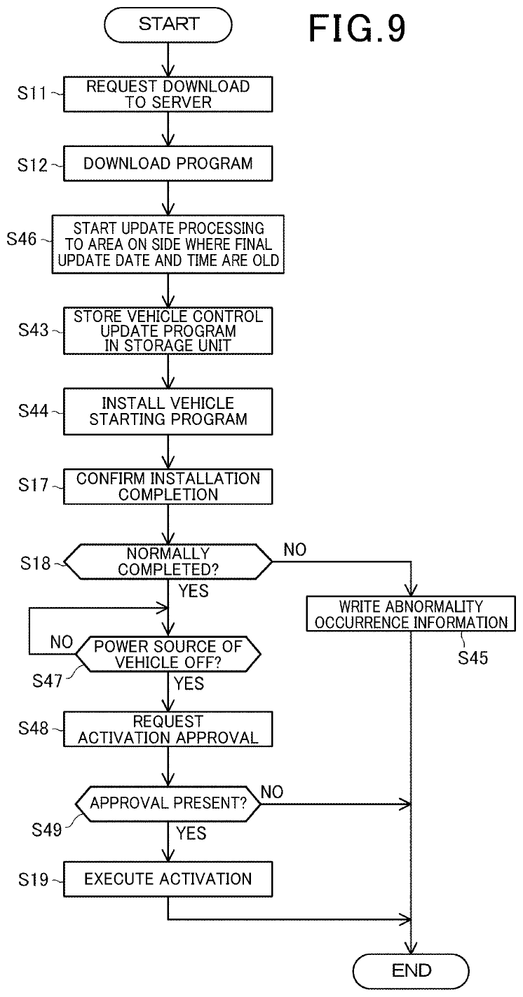

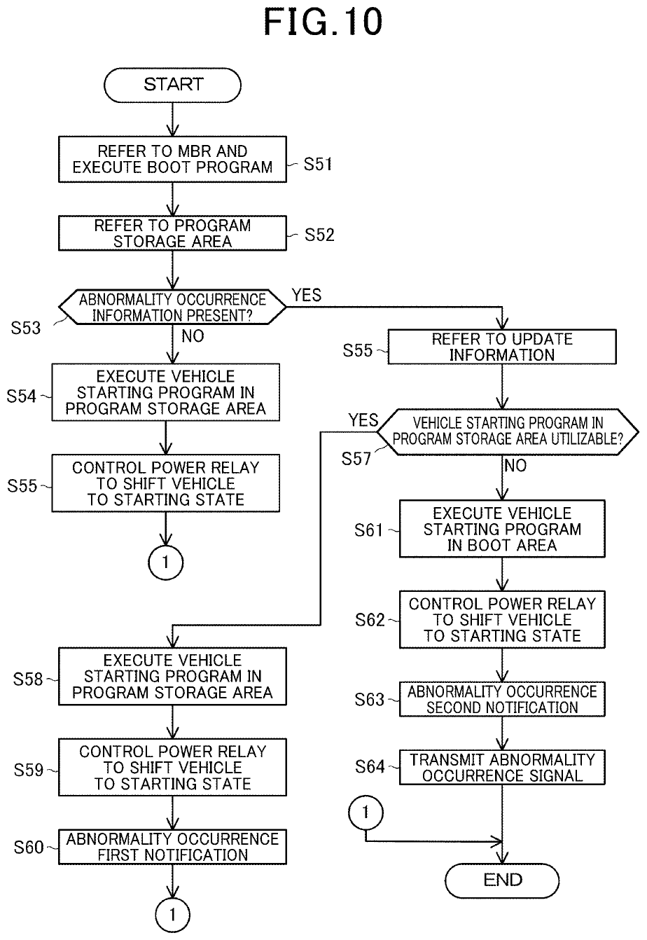

FIG. 8, FIG. 9 and FIG. 10 are flowcharts illustrating the operation of the control system 1 in the second embodiment. FIG. 8 and FIG. 9 illustrate the processing of updating the vehicle starting programs 85 and 86 stored in the storage unit 53A. FIG. 9 is a modification of the operation illustrated in FIG. 8. Steps S14 and S41 to S44 in FIG. 8 correspond to an example of the update processing. Steps S46 and S43 to S44 in FIG. 9 correspond to an example of the update processing.

Since steps S11 to S14 and S17 to S19 in FIG. 8 are the operations similar to that in FIG. 5, the explanation is omitted here.

As illustrated in FIG. 8, after the update processing is started in step S14, the update execution unit 52 specifies one of the program storage first area 67 and the program storage second area 68 as an area of an update object (step S41). The update execution unit 52 generates update information and stores the update information in the storage unit 53A (step S42). The update information is information indicating whether or not the program on a side not to be updated is suitable for utilization. The update execution unit 52 generates the update information based on a reason for performing the update processing.

As an example, the case where the update execution unit 52 updates the vehicle starting program 85 stored in the program storage first area 67 will be explained. In this case, the update execution unit 52 selects the program storage first area 67 as the area of the update object in step S41. The update execution unit 52 generates the update information 88B for the vehicle starting program 86 stored in the program storage second area 68 which is not the area of the update object, and stores the update information 88B in the program storage second area 68. The update information 88B indicates whether or not the vehicle starting program 86 is suitable for the utilization. When the reason for performing the update processing is to dissolve the failures and the vulnerability of the vehicle starting program 86, the update execution unit 52 generates the update information 88B indicating that the vehicle starting program 86 is not suitable for the utilization. In addition, when the reason for performing the update processing is not to dissolve the failures and the vulnerability of the vehicle starting program 86, the update information 88B indicating that the vehicle starting program 86 is suitable for the utilization is generated. The reason for performing the update processing can be determined by additional information transmitted to the control system 1 by the server 110 together with the vehicle control update program, for example. In this case, the server 110 transmits the additional information indicating the reason for performing the update processing to the control system 1 when transmitting the vehicle control update program to the control system 1. Similarly, in the case of updating the vehicle starting program 86 stored in the program storage second area 68, the update execution unit 52 generates the update information 88A indicating whether or not the vehicle starting program 85 is suitable for the utilization and stores the update information 88A in the program storage first area 67. In addition, the update information 88A and the update information 88B may be a code or the like indicating the reason for performing the update processing.

The update execution unit 52 stores the vehicle control update program downloaded in step S12 in the area of the update object (step S43). The update execution unit 52 utilizes the vehicle control update program stored in step S43 to execute the installation of the vehicle starting program stored in the area of the update object (step S44). The processing in step S44 is similar to that in step S16.

Further, when it is determined that the installation is not normally completed in determination in step S18, the update execution unit 52 stores the abnormality occurrence information in the area of the update object. For example, when the processing of updating the vehicle starting program 85 is not normally completed, the update execution unit 52 stores the abnormality occurrence information 87A in the program storage first area 67 which is the area of the update object, in step S45.

FIG. 8 illustrates, similarly to FIG. 5, the operation that the update data control unit 203 stands by for the power source of the vehicle V to be switched OFF and the update processing is executed after the power source of the vehicle V is switched OFF. Since the storage unit 53A includes the storage area on the A side and the storage area on the B side, even while the power source of the vehicle V is ON, the update processing can be executed without affecting reliability of the program. The operation in this case is illustrated in FIG. 9.

In FIG. 9, steps S11, S12, S17 to S19 and S43 to S45 are the operations in common with FIG. 8 so that the explanation is omitted.

As illustrated in FIG. 9, after the update data reception unit 202 downloads the program in step S12, the update execution unit 52 selects the storage area and starts the update processing (step S46). In step S46, the update execution unit 52 selects the area on the side where final update date and time are old between the storage area on the A side and the storage area on the B side of the storage unit 53A, as the object of the update processing. In detail, the update execution unit 52 specifies the final update dates and time of the program storage first area 67 and the program storage second area 68. The final update date and time of the program storage first area 67 are the date and time when the program stored in the program storage first area 67 is updated last. The final update date and time of the program storage second area 68 are the same. The update execution unit 52 compares the final dates and time of the program storage first area 67 and the program storage second area 68, and selects the area on the side where the final update date and time are old. In step S46, the update execution unit 52 may generate the update information by the processing similar to that in step S42 and store the update information in the storage area on the side that is not selected.

After step S46, the update execution unit 52 shifts to step S43.

When the update execution unit 52 determines that the installation is normally completed in the determination in step S18 (step S18; YES), the update data control unit 203 determines presence/absence of an operation of turning OFF the power source of the vehicle V (step S47). The determination in step S47 may be similar to that in step S13. Alternatively, in step S47, the update data control unit 203 may determine the presence/absence of the operation of directing that the power source of the vehicle V is to be turned OFF. That is, not the fact that the power source of the vehicle V is actually turned OFF but the operation of directing it may be determined. An example of this kind of operation is the operation of an ignition switch of the vehicle V.

The update data control unit 203 stands by for the power source of the vehicle V to be switched OFF (step S47; NO). When it is determined that the power source of the vehicle V is to be switched OFF (step S47; YES), the update data control unit 203 performs the processing of requesting approval of the activation to the user (step S48). For example, in step S48, the update data control unit 203 executes at least one of the processing of displaying a message requesting the approval of the update on the touch panel loaded on the vehicle V and the processing of outputting a voice message requesting the approval of the update from the speaker loaded on the vehicle V. Here, in step S48, the update data control unit 203 may display an operation icon for the user to perform an approval operation or the like on the touch panel.

The update data control unit 203 determines whether or not the operation of approving the update is performed by the user (step S49). The operation of approving the update is an operation to the touch panel, for example. When it is determined that the operation of approving the update is not performed (step S49; NO), the update data control unit 203 ends the present processing. In this case, the update data control unit 203 performs the operation in step S48 thereafter every time the power source of the vehicle V is turned OFF.

When the operation of approving the update is performed (step S49; YES), by the control of the update data control unit 203, the update execution unit 52 executes the activation of the installed program (step S19), and ends the present processing. In step S19, the update execution unit 52 performs the setting such that the program installed in step S44 is executed when the power source of the vehicle V is turned ON next.

The update execution unit 52 and the update data control unit 203 may be configured to alternatively execute one of the operation of FIG. 8 and the operation of FIG. 9.

In addition, the update execution unit 52 and the update data control unit 203 may be configured to be able to execute both of the operation of FIG. 8 and the operation of FIG. 9 and select and execute one of them. For example, the update data control unit 203 may be configured to execute the operation of FIG. 8 when the reason for performing the update processing is to dissolve the failures and the vulnerability of the vehicle starting program 86. In this case, when the reason for performing the update processing is not to dissolve the failures and the vulnerability of the vehicle starting program 86, the update execution unit 52 and the update data control unit 203 execute the operation of FIG. 8 or FIG. 9. In program update processing, it is needed to consider the fact that it becomes impossible to execute an original program by overwriting and updating the program stored in the storage unit 53A. When both of the program stored in the program storage first area 67 and the program stored in the program storage second area 68 work properly with no trouble when executed by the program execution unit 51, reliability is not affected no matter which is updated. In such a case, the storage unit 53A stores the executable program in both of the program storage first area 67 and the program storage second area 68.

Accordingly, even when the power source of the vehicle V is not turned OFF, the program can be updated without affecting the reliability of the program. In this case, the operation of FIG. 9 has an advantage that the update processing can be executed while the power source of the vehicle V is ON.

FIG. 10 illustrates the operation regarding the starting of the second zone ECU 20b. The operation of FIG. 10 can be executed in both of the case where the update of the program is executed just as FIG. 8 and the case where the update of the program is executed just as FIG. 9.

The program execution unit 51 refers to the master boot record (MBR) 81, and selects and executes the boot program 83 or the boot program 84 (step S51). In step S51, the program execution unit 51 selects one of the A-side boot image storage area 65 and the B-side boot image storage area 66, that is, one of the A side and the B side. For example, the program execution unit 51 compares the final update dates and time of the vehicle starting program 85 and the vehicle starting program 86 by the function of the program included in the master boot record 81. In this case, the program execution unit 51 selects the area on the side storing the vehicle starting program on the side where the final update date and time are latest, between the A side and the B side.

Hereinafter, as an example, the case where the program execution unit 51 selects and executes the program on the A side in step S51 will be explained. The operation in the case where the program execution unit 51 selects the program on the B side will be similarly understood.

When the boot program 83 is executed in step S51, the program execution unit 51 refers to the program storage first area 67 (step S52) and determines whether or not the abnormality occurrence information 87A is stored (step S53).

When the abnormality occurrence information 87A is not stored (step S53; NO), the program execution unit 51 executes the vehicle starting program 85 stored in the program storage first area 67 (step S54). By executing the vehicle starting program 85, the program execution unit 51 makes the ECU 30k switch the power relay 41 to start the vehicle V (step S55). Thus, the state where the control system 1 can control the functions required for the traveling of the vehicle V is attained, and the vehicle V is shifted to the power ON state.

When the abnormality occurrence information 87A is stored in the program storage first area 67 (step S53; YES), the program execution unit 51 refers to the update information 88B (step S55). In step S55, the program execution unit 51 refers to the storage area on the side not referred to in step S52, that is, the update information 88B stored in the program storage second area 68.

Based on the update information 88B referred to in step S55, the program execution unit 51 determines whether or not the vehicle starting program 86 in the program storage second area 68 can be utilized (step S57).

When it is determined that the vehicle starting program 86 can be utilized (step S57; YES), the program execution unit 51 executes the vehicle starting program 86 (step S58). By executing the vehicle starting program 86, the program execution unit 51 makes the ECU 30k switch the power relay 41 to start the vehicle V (step S59). Thus, the state where the control system 1 can control the functions required for the traveling of the vehicle V is attained, and the vehicle V is shifted to the power ON state.

Thereafter, the update control unit 201 or the program execution unit 51 provides abnormality occurrence first notification (step S60). Abnormality occurrence first notification is the notification indicating that the update processing of the vehicle starting program 85 is not normally completed, and is the notification performed when the vehicle starting program 86 can be executed. A notification method of the abnormality occurrence first notification is similar to the abnormality occurrence notification executed in step S38.

When it is determined that the vehicle starting program 86 can not be utilized (step S57; NO), the program execution unit 51 executes the vehicle starting program 82 stored in the boot area 61A (step S61). By executing the vehicle starting program 82, the program execution unit 51 makes the ECU 30k switch the power relay 41 to start the vehicle V (step S62). Thus, the state where the control system 1 can control the functions required for the traveling of the vehicle V is attained, and the vehicle V is shifted to the power ON state.

Thereafter, the update control unit 201 or the program execution unit 51 provides abnormality occurrence second notification (step S60). The abnormality occurrence second notification is the notification indicating that the update processing of the vehicle starting program 85 is not normally completed and the vehicle starting program 86 is not suitable for the utilization. The abnormality occurrence first notification is notified when one of the vehicle starting programs 85 and 86 stored in the storage unit 53A can be normally utilized and the update processing of the other has not been successful. The situation can be dissolved by redoing the update processing. In contrast, the abnormality occurrence second notification indicates that both of the vehicle starting programs 85 and 86 stored in the storage unit 53A are not suitable for the utilization and the vehicle V has been started by utilizing the vehicle starting program 82 for emergency so to speak. The vehicle starting program 82 is the program having the functions satisfying a standard for making the vehicle V safely travel, but the functions are limited compared to the vehicle starting programs 85 and 86. Therefore, it is desirable to quickly cope with the state where the vehicle V is started by the vehicle starting program 82.

For example, it is desirable to update or repair at least one of the vehicle starting programs 85 and 86 by connecting the vehicle diagnostic device 120 to the DLC 19 in the shop or the maintenance facility of the vehicle V.

Accordingly, the abnormality occurrence first notification has the contents that urge the user to redo the update processing, for example. In contrast, the abnormality occurrence second notification has the contents that demand coping in an early stage to the user, for example. Therefore, it is desirable that a mode of the abnormality occurrence first notification and a mode of the abnormality occurrence second notification are different so as to be clearly distinguished by the user. For the notification method of the abnormality occurrence second notification, the method similar to the abnormality occurrence first notification executed in step S60 can be adopted.

After providing the abnormality occurrence second notification, the update control unit 201 or the program execution unit 51 transmits the abnormality occurrence signal to the external device (step S64). The abnormality occurrence signal is similar to the signal transmitted in step S39.

The embodiments described above illustrate one specific example to which the present invention is applied, and do not limit a form of invention application.

The embodiments described above explain the operation in the case where the control system 1 updates the vehicle starting programs 72, 85 and 86 stored in the storage units 53 and 53A based on the vehicle control update program downloaded from the server 110. The present invention is not limited thereto, and for example, the operation illustrated in FIG. 5 or FIG. 8 may be executed when the control system 1 receives the vehicle control update program from the vehicle diagnostic device 120 connected to the DLC 19. That is, the operation of the embodiments described above may be applied when the control system 1 acquires the vehicle control update program from the vehicle diagnostic device 120 as the external device and updates the vehicle starting program.

In addition, the embodiments described above explain, as an example, the case of updating the vehicle starting programs 72, 85 and 86 to be executed by the second zone ECU 20b provided in the control system 1. This is an example. It is of course possible to apply the configuration of the storage units 53 and 53A and the operation of the program execution unit 51 and the update execution unit 52 explained in the present embodiments to the central ECU 2 and the other ECUs, for example.

In addition, the embodiments described above explain the example of applying the present invention to the update processing of updating the vehicle starting program required to start the vehicle V. This is an example, and the configuration and the operation of the present embodiments can be applied for the update processing of updating the program regarding the functions of the vehicle V.

Further, the embodiments described above explain the example of providing the abnormality occurrence notification, the abnormality occurrence first notification or the abnormality occurrence second notification when the installation of the vehicle starting program is not normally completed. This is an example. The program execution unit 51 may provide the notification indicating that the update processing has been successful when, for example, the vehicle starting program updated by the update processing is executed, that is, when the update processing has been successful. In addition, a signal indicating that the update processing has been successful may be transmitted to the external device.

Also, the configuration of the control system 1 illustrated in the embodiments described above is an example, and the kind of the ECUs provided in the control system 1, the number of the ECUs and the configuration of the device which is the control object of the ECUs can be variously changed.

For ease of understanding of the present invention, FIG. 1 and FIG. 3 are the diagrams illustrating the schematic configuration in which functional configurations of the individual devices in the program management system 100 are divided by main processing contents and illustrated, and do not limit the configuration of the device. Each processing illustrated in FIG. 5, FIG. 6, FIG. 8, FIG. 9 and FIG. 10 may be executed by one program, or may be executed by a plurality of programs.

Further, while the vehicle V is a four-wheeled automobile for example, the kind of the vehicle V is not limited in particular and may be a large-sized automobile, a commercial vehicle, a two-wheeled vehicle, a three-wheeled vehicle or the like. In addition, the configuration of each unit in the control system 1 can be arbitrarily changed.

The embodiments described above support the following configurations.

(Configuration 1) A vehicle controller including: a vehicle control unit configured to control a vehicle by executing a vehicle starting program for starting the vehicle; a storage unit including a rewrite limited area and a rewrite possible area, the vehicle starting program being stored in the rewrite limited area, rewrite being limited in the rewrite limited area, the vehicle starting program being rewritably stored in the rewrite possible area; a communication unit configured to communicate with an external device; and a program update unit configured to execute update processing of storing a vehicle starting update program in the rewrite possible area, the vehicle starting update program being received by the communication unit, the vehicle starting update program being utilized for updating the vehicle starting program, wherein the vehicle control unit executes the vehicle starting program stored in the rewrite possible area and executes the vehicle starting program stored in the rewrite limited area when the update processing by the program update unit is not normally completed.

According to the vehicle controller of configuration 1, even when a trouble occurs in the update of the vehicle starting program, the vehicle can be started by utilizing the vehicle starting program stored in the area where the rewrite is limited. Since the vehicle starting program stored in the area where the rewrite is limited is not the object of the update, the vehicle starting program is maintained in an executable state. Therefore, since the situation where the vehicle starting program cannot be executed can be surely avoided, reliability regarding the update of the program which controls the vehicle can be secured.

(Configuration 2) The vehicle controller according to configuration 1, wherein the vehicle starting program includes a power relay control program, the power relay control program controlling a power relay of the vehicle.

According to the vehicle controller of configuration 2, the reliability regarding the update of the program which controls the power relay of the vehicle can be secured.

(Configuration 3) The vehicle controller according to configuration 1 or configuration 2, wherein the program update unit stores abnormality occurrence information in the storage unit when the update processing is not normally completed, the abnormality occurrence information indicating that the update processing is not normally completed.

According to the vehicle controller of configuration 3, the vehicle starting program for which the update processing is not normally completed can be surely identified by storing the information indicating that the update processing is not normally completed. For example, when the vehicle control unit is started to execute the vehicle starting program, the vehicle starting program for which the update processing is not normally completed can be prevented from being executed. Therefore, the higher reliability can be secured regarding the update of the program which controls the vehicle.

(Configuration 4) The vehicle controller according to configuration 3, wherein the vehicle control unit executes the vehicle starting program stored in the rewrite limited area when the abnormality occurrence information is stored in the storage unit.

According to the vehicle controller of configuration 4, the vehicle starting program for which the update processing is not normally completed can be distinguished based on the abnormality occurrence information. Thus, the vehicle is started by utilizing the vehicle starting program stored in the area where the rewrite is limited, without executing the vehicle starting program not suitable for the execution. Therefore, the higher reliability can be secured regarding the update of the program which controls the vehicle.

(Configuration 5) The vehicle controller according to any one of configuration 1 to configuration 4, further including a notification unit configured to provide abnormality occurrence notification indicating that the update processing is not normally completed, wherein the abnormality occurrence notification is provided by the notification unit when the vehicle control unit executes the vehicle starting program stored in the rewrite limited area.

According to the vehicle controller of configuration 5, the state of the vehicle can be reported to the user by notifying that the update processing of the vehicle starting program is not normally completed. By the notification, for example, the re-execution of the update processing of the vehicle starting program and the repair of the vehicle starting program can be urged. Therefore, even when a trouble occurs in the update of the program which controls the vehicle, the user can perform more appropriate coping.

(Configuration 6) The vehicle controller according to configuration 5, wherein an abnormality occurrence signal is transmitted to the external device by the communication unit when the abnormality occurrence notification is provided by the notification unit, the abnormality occurrence signal indicating that the update processing is not normally completed.

According to the vehicle controller of configuration 6, it can be reported to the external device that the update processing of the vehicle starting program is not normally completed. By the notification, it can be detected or recorded by the external device that the update processing of the vehicle starting program is not normally completed. Thus, for example, the user can be supported from the outside regarding the re-execution of the update processing of the vehicle starting program and the repair of the vehicle starting program.

(Configuration 7) The vehicle controller according to configuration 1, wherein the storage unit includes, in the rewrite possible area, a first storage area and a second storage area, the first storage area being configured to store the vehicle starting program and the vehicle starting update program, the second storage area being configured to store the vehicle starting program and the vehicle starting update program, and the program update unit executes the update processing of storing the vehicle starting update program in at least one of the first storage area and the second storage area, and stores abnormality occurrence information in the first storage area when the update processing of storing the vehicle starting update program in the second storage area is not normally completed, the abnormality occurrence information indicating that the update processing is not normally completed.

According to the vehicle controller of configuration 7, the vehicle starting program can be held also in the area not affected by the update during updating of the vehicle starting program so that it is not required to limit a timing of updating the program in preparation for trouble occurrence in the update of the program. Accordingly, the limitation of the timing of updating the program can be reduced. Then, when a trouble occurs in the update processing, the vehicle can be started by utilizing the vehicle starting program stored in the area where the rewrite is limited. That is, even in the state where both of the vehicle starting program for which the update is not normally completed and the vehicle starting program which is not updated are not suitable for the execution, the vehicle can be started. Further, the vehicle starting program for which the update processing is not normally completed can be distinguished based on the abnormality occurrence information. Thus, the vehicle can be started by utilizing the vehicle starting program stored in the area where the rewrite is limited, without executing the vehicle starting program not suitable for the execution. Accordingly, the vehicle can be surely started and the higher reliability can be secured regarding the update of the program which controls the vehicle.

(Configuration 8) The vehicle controller according to configuration 7, wherein the vehicle control unit selects and executes the vehicle starting program stored in the first storage area or the vehicle starting program stored in the second storage area based on the abnormality occurrence information when the vehicle starting program is stored in the first storage area and the second storage area.

According to the vehicle controller of configuration 8, the vehicle starting program for which the update processing is not normally completed is distinguished based on the abnormality occurrence information. Thus, the vehicle can be started by utilizing the vehicle starting program stored in the area where the rewrite is limited, without executing the vehicle starting program not suitable for the execution. Accordingly, the vehicle can be surely started and the higher reliability can be secured regarding the update of the program which controls the vehicle.

(Configuration 9) The vehicle controller according to configuration 7 or configuration 8, further including a notification unit configured to notify that the update processing is not normally completed, wherein abnormality occurrence first notification is provided by the notification unit when the vehicle control unit executes the vehicle starting program stored in the first storage area based on the abnormality occurrence information.

According to the vehicle controller of configuration 9, the state of the vehicle can be reported to the user by notifying that the update processing of the vehicle starting program is not normally completed. By the notification, for example, the re-execution of the update processing of the vehicle starting program can be urged. Therefore, even when a trouble occurs in the update of the program which controls the vehicle, the user can perform more appropriate coping.

(Configuration 10) The vehicle controller according to configuration 9, wherein abnormality occurrence second notification is provided by the notification unit when the vehicle control unit executes the vehicle starting program stored in the rewrite limited area, the abnormality occurrence second notification being different from the abnormality occurrence first notification.

According to the vehicle controller of configuration 10, it can be notified that it is the state where both of the vehicle starting program for which the update is not normally completed and the vehicle starting program which is not updated are not suitable for the execution. Since the abnormality occurrence second notification is different from the abnormality occurrence first notification which urges the re-execution of the update processing of the vehicle starting program, it can be reported to the user that quicker coping is needed.

(Configuration 11) The vehicle controller according to configuration 10, wherein an abnormality occurrence signal is transmitted to the external device by the communication unit when the abnormality occurrence second notification is provided by the notification unit, the abnormality occurrence signal indicating that the update processing is not normally completed.

According to the vehicle controller of configuration 11, it can be reported to the external device that the update processing of the vehicle starting program is not normally completed and the vehicle starting program which is not updated is also in the state not suitable for the execution. Thus, for example, the user can be supported from the outside regarding the re-execution of the update processing of the vehicle starting program and the repair of the vehicle starting program.

(Configuration 12) A vehicle control method utilizing a vehicle controller including a communication unit configured to communicate with an external device present outside a vehicle and a storage unit configured to store a vehicle starting program for starting the vehicle, the storage unit including a rewrite limited area and a rewrite possible area, the vehicle starting program being stored in the rewrite limited area, rewrite being limited in the rewrite limited area, the vehicle starting program being rewritably stored in the rewrite possible area, the vehicle control method including: executing update processing of storing a vehicle starting update program in the rewrite possible area, the vehicle starting update program being received by the communication unit, the vehicle starting update program being utilized for updating the vehicle starting program; executing the vehicle starting program stored in the rewrite possible area to start the vehicle; and executing the vehicle starting program stored in the rewrite limited area when the update processing is not normally completed.

According to the vehicle control method of configuration 12, even when a trouble occurs in the update of the vehicle starting program, the vehicle can be started by utilizing the vehicle starting program stored in the area where the rewrite is limited. Since the vehicle starting program stored in the area where the rewrite is limited is not the object of the update, the vehicle starting program is maintained in the executable state. Therefore, since the situation where the vehicle starting program cannot be executed can be surely avoided, the reliability regarding the update of the program which controls the vehicle can be secured.

(Configuration 13)

A recording medium storing a program to be executed by a computer, the computer being configured to control a vehicle controller including a communication unit configured to communicate with an external device present outside a vehicle and a storage unit configured to store a vehicle starting program for starting the vehicle, the storage unit including a rewrite limited area and a rewrite possible area, the vehicle starting program being stored in the rewrite limited area, rewrite being limited in the rewrite limited area, the vehicle starting program being rewritably stored in the rewrite possible area, the program causing the computer to: execute update processing of storing a vehicle starting update program in the rewrite possible area, the vehicle starting update program being received by the communication unit, the vehicle starting update program being utilized for updating the vehicle starting program; executing the vehicle starting program stored in the rewrite possible area to start the vehicle; and execute the vehicle starting program stored in the rewrite limited area when the update processing is not normally completed.

According to the program recorded in the recording medium of configuration 13, even when a trouble occurs in the update of the vehicle starting program, the vehicle can be started by utilizing the vehicle starting program stored in the area where the rewrite is limited. Since the vehicle starting program stored in the area where the rewrite is limited is not the object of the update, the vehicle starting program is maintained in the executable state. Therefore, since the situation where the vehicle starting program cannot be executed can be surely avoided, the reliability regarding the update of the program which controls the vehicle can be secured.

### REFERENCE SIGNS LIST

1 . . . control system (vehicle controller), 2 . . . central ECU, 12 . . . TCU (communication unit), 19 . . . DLC (communication unit), 20 . . . zone ECU, 20a . . . first zone ECU, 20b . . . second zone ECU, 20c . . . third zone ECU, 30, 30a, 30b, 30c, 30d, 30e, 30f, 30g, 30h, 30i, 30j, 30k, 30l, 30m, 30n . . . ECU, 41 . . . power relay, 51 . . . program execution unit (vehicle control unit), 52 . . . update execution unit (program update unit), 53, 53A . . . storage unit, 61, 61A . . . boot area (rewrite limited area), 62 . . . program storage area (rewrite possible area), 67 . . . program storage first area (rewrite possible area), 68 . . . program storage second area (rewrite possible area), 72 . . . vehicle starting program, 73 . . . vehicle starting program, 74 . . . abnormality occurrence information, 81 . . . master boot record, 82 . . . vehicle starting program, 85, 86 . . . vehicle starting program, 87A, 87B . . . abnormality occurrence information, 88A, 88B . . . update information, 100 . . . program management system, 110 . . . server, 120 . . . vehicle diagnostic device, 201 . . . update control unit, 202 . . . update data reception unit, 203 . . . update data control unit, V . . . vehicle.

What is claimed is:

1. A vehicle controller comprising:
a vehicle control unit configured to control a vehicle by executing a vehicle starting program for starting the vehicle;
a storage unit including a rewrite limited area and a rewrite possible area, the vehicle starting program being stored in the rewrite limited area, rewrite being limited in the rewrite limited area, the vehicle starting program being rewritably stored in the rewrite possible area;
a communication unit configured to communicate with an external device; and
a program update unit configured to execute update processing of storing a vehicle starting update program in the rewrite possible area, the vehicle starting update program being received by the communication unit, the vehicle starting update program being utilized for updating the vehicle starting program,
wherein the vehicle control unit executes the vehicle starting program stored in the rewrite possible area and executes the vehicle starting program stored in the rewrite limited area when the update processing by the program update unit is not normally completed.

2. The vehicle controller according to claim 1,
wherein the vehicle starting program includes a power relay control program, the power relay control program controlling a power relay of the vehicle.

3. The vehicle controller according to claim 1,
wherein the program update unit stores abnormality occurrence information in the storage unit when the update processing is not normally completed, the abnormality occurrence information indicating that the update processing is not normally completed.

4. The vehicle controller according to claim 3,
wherein the vehicle control unit executes the vehicle starting program stored in the rewrite limited area when the abnormality occurrence information is stored in the storage unit.

5. The vehicle controller according claim 1, further comprising
a notification unit configured to provide abnormality occurrence notification indicating that the update processing is not normally completed,
wherein the abnormality occurrence notification is provided by the notification unit when the vehicle control unit executes the vehicle starting program stored in the rewrite limited area.

6. The vehicle controller according to claim 5,
wherein an abnormality occurrence signal is transmitted to the external device by the communication unit when the abnormality occurrence notification is provided by the notification unit, the abnormality occurrence signal indicating that the update processing is not normally completed.

7. The vehicle controller according to claim 1,
wherein the storage unit includes, in the rewrite possible area, a first storage area and a second storage area, the first storage area being configured to store the vehicle starting program and the vehicle starting update program, the second storage area being configured to store the vehicle starting program and the vehicle starting update program, and
the program update unit
executes the update processing of storing the vehicle starting update program in at least one of the first storage area and the second storage area, and
stores abnormality occurrence information in the first storage area when the update processing of storing the vehicle starting update program in the second storage area is not normally completed, the abnormality occurrence information indicating that the update processing is not normally completed.

8. The vehicle controller according to claim 7,
wherein the vehicle control unit selects and executes the vehicle starting program stored in the first storage area or the vehicle starting program stored in the second storage area based on the abnormality occurrence information when the vehicle starting program is stored in the first storage area and the second storage area.

9. The vehicle controller according to claim 7, further comprising
a notification unit configured to notify that the update processing is not normally completed,
wherein abnormality occurrence first notification is provided by the notification unit when the vehicle control unit executes the vehicle starting program stored in the first storage area based on the abnormality occurrence information.

10. The vehicle controller according to claim 9,
wherein abnormality occurrence second notification is provided by the notification unit when the vehicle control unit executes the vehicle starting program stored in the rewrite limited area, the abnormality occurrence second notification being different from the abnormality occurrence first notification.

11. The vehicle controller according to claim 10,
wherein an abnormality occurrence signal is transmitted to the external device by the communication unit when the abnormality occurrence second notification is provided by the notification unit, the abnormality occurrence signal indicating that the update processing is not normally completed.

12. A vehicle control method utilizing a vehicle controller including a communication unit configured to communicate with an external device present outside a vehicle and a storage unit configured to store a vehicle starting program for starting the vehicle,
the storage unit including a rewrite limited area and a rewrite possible area, the vehicle starting program being stored in the rewrite limited area, rewrite being limited in the rewrite limited area, the vehicle starting program being rewritably stored in the rewrite possible area,
the vehicle control method comprising:
executing update processing of storing a vehicle starting update program in the rewrite possible area, the vehicle starting update program being received by the communication unit, the vehicle starting update program being utilized for updating the vehicle starting program;
executing the vehicle starting program stored in the rewrite possible area to start the vehicle; and
executing the vehicle starting program stored in the rewrite limited area when the update processing is not normally completed.

13. A non-transitory computer-readable recording medium storing a program to be executed by a computer, the computer being configured to control a vehicle controller including a communication unit configured to communicate with an external device present outside a vehicle and a storage unit configured to store a vehicle starting program for starting the vehicle,
the storage unit including a rewrite limited area and a rewrite possible area, the vehicle starting program being stored in the rewrite limited area, rewrite being limited in the rewrite limited area, the vehicle starting program being rewritably stored in the rewrite possible area,
the program causing the computer to:
execute update processing of storing a vehicle starting update program in the rewrite possible area, the vehicle starting update program being received by the communication unit, the vehicle starting update program being utilized for updating the vehicle starting program;
executing the vehicle starting program stored in the rewrite possible area to start the vehicle; and
execute the vehicle starting program stored in the rewrite limited area when the update processing is not normally completed.
